(19) United States
(12) Patent Application Publication
(10) Pub. No.: US 2024/0337611 A1
(43) Pub. Date: Oct. 10, 2024

(54) METHOD FOR DISLOCATION ANALYSIS

(71) Applicant: OXFORD INSTRUMENTS NANOTECHNOLOGY TOOLS LIMITED, Abingdon Oxon (GB)

(72) Inventor: Aimo WINKELMANN, Paderborn (DE)

(21) Appl. No.: 18/713,247

(22) PCT Filed: Nov. 25, 2022
(86) PCT No.: PCT/GB2022/053001

§ 371 Date: May 24, 2024

(30) Foreign Application Priority Data
Nov. 25, 2021 (GB) 2117055.0

(51) Int. Cl. G01N 23/203

(52) U.S. Cl. CPC G01N 23/203; G01N 2223/60

(57) ABSTRACT

A method for analysing lattice distortion in a specimen is provided. The method comprises, for each of a plurality of target locations in a specimen: obtaining crystal lattice orientation information for the specimen at each of a plurality of perimeter locations along a path corresponding to a perimeter of a region of the specimen that contains the target location; and generating, in accordance with the obtained crystal lattice orientation information, distortion information for the target location within the region, the distortion information being representative of crystal lattice distortion attributable to crystal lattice dislocations within the region. Each region containing one of the plurality of target locations partially overlaps another region, containing a different one of the said target locations. The method further comprises outputting a set of output data comprising the generated distortion information for the plurality of target locations.

### FIELD OF THE INVENTION

The present invention relates to a method for analysing dislocations in a specimen. In particular it may provide improved spatial resolution and accuracy of information when analysing lattice distortions in a specimen.

### BACKGROUND TO THE INVENTION

### Introduction to EBSD

Electron backscatter diffraction (EBSD) is a well-established technique for the analysis of crystalline materials. It is a technique that enables the characterisation of materials across a range of scales, from nanometre (nm) to centimetre (cm), providing information such as the identification of phases, the distribution of phases, the orientation of the crystal lattice within individual grains, the size and shape of grains, the texture (i.e. the nature and strength of any preferred alignment of the crystal lattice within samples), the characteristics of boundaries between and within grains, and the nature of the material's response to any deformation. The technique uses a detector to capture electron diffraction patterns (“Kikuchi patterns”) that are generated by focusing an electron beam onto the surface of a sample in a scanning electron microscope (SEM). The technique can operate in a conventional backscattered geometry to analyse the polished surface of a bulk sample (EBSD), or can use a transmission geometry on samples that are polished until they are electron transparent, with the electron diffraction pattern imaged using transmitted electrons (sometimes referred to as transmission EBSD or transmission Kikuchi diffraction—TKD).

The data acquired using EBSD is typically an array of measurements collected from a regular square or hexagonal grid of analysis points on the surface of the sample. Each measurement contains confirmation of the phase at that point and details of the 3-dimensional orientation of the crystal lattice, relative to the sample surface. Additional information regarding the chemical composition at each point may optionally be stored (using simultaneous X-ray measurements), as well as various parameters relating to the quality of the electron diffraction pattern. It is standard procedure to use the grid of phase and orientation measurements to reconstruct the characteristics of the sample surface in the form of a map. The information shown in the map can be tailored to highlight the required characteristic: for example, a colouring scheme can be used that converts the 3D crystal lattice orientation into colours that describe its relationship to the sample coordinate system. In such an orientation map, regions with similar colours are easily visualised as “grains”, and a dominant colour may indicate a stronger crystallographic texture. An example orientation map is shown in FIG. 1.

### Strain and Dislocations

In many cases EBSD is a technique used to examine the characteristics of deformation in samples. When a sample is subjected to stress, for example due to applying forces in tension or compression, then the material can change size or shape. This can be measured as strain and, if the size or shape change is retained when the forces are removed, then it is known as plastic strain or plastic deformation. Plastic strain is possible because of the formation and movement of dislocations within the crystalline lattice. Dislocations can be described as line imperfections, in which some atoms are out of position within the crystal lattice. Effectively there are two types of dislocation-edge dislocations and screw dislocations, although most dislocations are likely a combination of the two. These are represented in FIG. 2.

This shows several key characteristics of dislocations, including the fact that the dislocation causes small local changes in orientation of the crystal lattice, and that dislocations can (in part) be characterised by their Burgers vector. The Burgers vector (b-marked with the red arrow on each dislocation in the image) can be defined as the final offset after tracing an equal-sided (in terms of atomic steps) loop about the dislocation line t-a so-called “Burgers circuit” (green arrows in the image). In effect the Burgers vector is the direction of slip on a slip plane and will provide important information about how the crystal is deforming in response to stress.

Dislocations can be assigned a direction or sign: if the dislocations in a material have random signs, then they will not result in any overall change in crystallographic orientation—the small changes in orientation about each dislocation are cancelled out. All materials contain such dislocations with mixed signs and these are sometimes referred to as statistically stored dislocations (SSDs). However, if dislocations are predominantly of the same sign, then they will result in a measurable orientation change. These dislocations are usually referred to as geometrically necessary dislocations (GNDs), and this is shown in FIG. 3.

EBSD is a good technique for measuring the accumulated lattice bending caused by GNDs, as the orientation changes usually exceed the detection limit of the technique (typically about) 0.1°. Many researchers use EBSD to characterise the nature of the plastic deformation within samples, by measuring the orientation changes within individual grains. This can then provide information about the localisation of deformation (for example, associated with the propagation of cracks through the materials), the activation of specific slip systems and the density of GNDs.

### Dislocation Density Measurements

The measurement of GND density using EBSD is increasingly common and is based upon the work of J. F. Nye, “Some geometrical relations in dislocated crystals”, Acta Mater. 1 (1953) 153-162., who derived formulae linking the curvature of the crystal lattice with the density of dislocations. Given that conventional EBSD measures the crystallographic orientations on a 2D plane in the sample, the technique cannot measure the full z component of the necessary rotation tensor and thus the measurement of GND density will usually be a lower limit of the true density. However, even this will be invaluable to many researchers and provides information about the physical properties of the material.

Most existing techniques to derive GND densities from EBSD data will measure the local change in orientation in the immediate vicinity of each analysis point. This approach, commonly known as “Kernel Average Misorientation” (KAM), calculates the mean difference in orientation between each measurement and the measurements on the perimeter of a user-defined pixel array about that point.

FIG. 4 shows a schematic illustration of the determination of a KAM value on a pixel array excluding those analysis points that are across a high angle grain boundary (marked by the red crosses) and an example KAM map of a cracked duplex stainless steel sample, showing the increase in plastic strain at the crack tips.

The KAM measurement quantifies the local orientation gradient, which in turn can be linked to the GND density. The approach given in W. Pantleon, “Resolving the geometrically necessary dislocation content by conventional electron backscattering diffraction”, Scr. Mater. 58 (2008) 994-997 is commonly used as a basis for calculating GND densities from the local curvature of the lattice. For example, P. J. Konijnenberg, S. Zaefferer and D. Raabe, “Assessment of geometrically necessary dislocation levels derived by 3D EBSD”, Acta Materialia 99 (2015) 402-414 treated the orientation change between the central pixel and each surrounding pixel as a single low angle boundary (with disorientation θ), and then used the average misorientation between the central pixel and its neighbours (θₐᵥ), the measurement step size, a, and the Burgers vector magnitude (|b|) to determine the total dislocation length per boundary fragment as:

$$L = {a}^{2} {θ}_{av} / \vert b \vert$$

This can then be converted into a GND density in either 2D or 3D by applying the relevant geometrical calculations.

However, in the same work of Konijnenberg et al., they showed how a Burgers circuit can also be applied in sample coordinates, and not only in crystallographic coordinates. This is shown in FIG. 5, which depicts Burgers circuits in crystal (left) and sample (right) reference frames. It can be seen that they both give the same Burgers vector (central arrow, b): in the case of the sample reference frame the loop is closed, so b is the net sum of the individual vectors at each step (small red arrows). For the loop in Crystal coordinates, the Burgers vector is the incomplete section of the circuit.

This is the approach that was taken by J. Wheeler, E. Mariani, S. Piazolo, D. J. Prior, P. Trimby, M. R. Drury, “The weighted Burgers vector: a new quantity for constraining dislocation densities and types using electron backscatter diffraction on 2D sections through crystalline materials”, J. Microscopy 233 (2009) 482-494, in which the “Weighted Burgers Vector” (WBV) was defined as: W=sum, over all types of dislocations, of [(density of intersections of dislocation lines with map)×(Burgers vector)]

The standard way to calculate the WBV is via a “differential” approach, in the same way as described above and used for calculating KAM maps: i.e. calculating the local orientation gradient at each point and determining the necessary dislocation content to account for that gradient.

However, Wheeler et al introduced the concept of an “integral loop” approach to measuring the WBV. The differential approach depends on the precise measurement of small changes in orientation, with any error in that measurement resulting in a significant error in the final GND density value. Summing the orientation changes around a loop on the sample surface will minimise the errors associated with poor angular precision, and so an integral loop approach can give more reliable GND density values. In Wheeler's paper, integral loops were shown as an interactive approach that could be taken to examine features or areas of interest.

FIGS. 6 and 7 show the use of the integral loop approach to determine the WBV values. FIG. 6 is an orientation map of a Mg-alloy showing the location of 6 user-specified WBV loops. The table shown in FIG. 7 shows (for sample Mg 4.3a) the equivalent WBVs for each of these loops.

The WBVs calculated using the integral loop approach permit the examination of particular features within a dataset (such as arrays of dislocations, or “low angle boundaries”) but, if the loop encloses multiple dislocations with different properties, then the integral WBVs will give the sum of these dislocations and may provide misleading information. In addition, the integral loop approach does not permit an automated overview of the dislocation characteristics of a whole dataset.

In response to this, Wheeler implemented a “tiling” approach. Here, the EBSD dataset is subdivided into a series of equally sized tiles (e.g. 5×5 pixels) and an integral loop is performed around the perimeter of each tile. This then generates a more reliable overview of the whole dataset (in that each tile is less susceptible to WBV errors caused by noise in the orientation measurement), but with several drawbacks:
1. Spatial Resolution—the dataset resolution decreases by a factor of n, where n=the tile side length. This renders the technique ill-suited to the analysis of finer microstructural features.
2. Tile shape-due to the tiling, the loop shapes (when using data collected on an orthogonal grid) must be rectangular or square. This introduces a measurement bias towards structures parallel to X or Y.

In addition, when the loop crosses over an analysis point with a significantly different orientation (e.g. >5° difference) or a pixel indexed as a different phase, then the integral loop will not return a valid WBV result and that tile will contain no information.

FIG. 8 schematically illustrates the basic WBV integral loop tiling approach, using 5×5 sized tiles. The final data, right, has significantly lower resolution than the original data.

This WBV tiling approach has been utilised in one publication to date (N. Timms, M. Pearce et al., New shock microstructures in titanite (CaTiSiO5) from the peak ring of the Chicxulub impact structure, Mexico, Contributions to Mineralogy and Petrology (2019), 174:38).

There exists a need for a technique for analysing lattice dislocations that provides a high level of accuracy while retaining a high spatial resolution.

### SUMMARY OF THE INVENTION

In accordance with a first aspect of the invention there is provided a method for analysing lattice distortion in a specimen, the method comprising: for each of a plurality of target locations in a specimen: obtaining crystal lattice orientation information for the specimen at each of a plurality of perimeter locations along a path corresponding to a perimeter of a region of the plane that contains the target location; and generating, in accordance with the obtained crystal lattice orientation information, distortion information for the target location within the region, the distortion information being representative of crystal lattice distortion attributable to crystal lattice dislocations within the region, wherein each region containing one of the plurality of target locations partially overlaps another region, containing a different one of the said target locations, and outputting a set of output data comprising the generated distortion information for the plurality of target locations.

The method provides an approach for analysing lattice dislocations to obtain distortion information that overcomes the existing issues described above. That is, the inventors have realised that, by generating distortion information for each of a plurality of target locations using crystal lattice orientation information from around the perimeter of respective regions containing those target locations, and doing so in such a way that the regions overlap one another, the accuracy of distortion information across those target locations is improved, without compromising the spatial resolution of the obtained data. In this way, the method is capable of providing output data comprising distortion information that can indicate that the dominant kind of dislocation for each of the target locations, or corresponding regions containing them, without the loss of information caused by conventional tile-based approaches.

Thus the method can advantageously provide high-resolution dislocation information maps or images, for example, that may indicate the response of a specimen material to stress across the plurality of target locations. This key benefit may be understood, for example, in view of prior art techniques involving non-overlapping “tiles”, in which different or conflicting dislocation types occurring within a given tile region might result in information or indications of those different types being lost or omitted from data obtained for the tile overall.

The method may be used to produce a set of output data for a target portion of the specimen, which may also be called a mapping portion, in reference to the possibility for producing a map or image representative of the distortion in that portion using the output data. Accordingly the plurality of target locations are preferably within, and may themselves define, the target portion of the specimen. Typically the target portion, and in particular any of its position, orientation, and extent, relative to the specimen itself, is restricted by, or at least established by virtue of, the particular parts of the specimen that have been scanned in order to acquire the set of data, which may be called an orientation dataset, from which the crystal lattice orientation information can be obtained. However, in some embodiments, where the initial data set is more extensive for instance, the target portion may be selected as a portion of a larger part of the specimen. The plurality of target locations may be understood as lying in, corresponding to, or defining, a portion or section of the specimen that is to be analysed.

The target portion, or in other words the portion of the specimen in which the plurality of locations used in the method are situated, may correspond to, or be thought of or represented as, a surface, or a part of a surface. Although some embodiments may involve the target portion being located on, or conforming to, a surface that is specifically an external or outer surface of the specimen, it will be understood that the term “surface” as used in the context refers, more generally, to any topological space of dimension two, and is therefore not restricted to outer surfaces. The term will be understood to mean that a moving point on such a surface, of which the target portion may be considered to be a part, may move in two directions (having two degrees of freedom) or, in other words, that around almost every point, there is a coordinate patch on which a two-dimensional coordinate system is defined.

It will also be understood that, in general, a surface is a continuous boundary dividing a three-dimensional space into two sub-spaces. For example, if the surface in which the target locations lie is an external surface of the specimen, then it is the continuous boundary between a three-dimensional section of the specimen and a three-dimensional region outside of it. As an alternative example, if the surface is interior to the specimen, for instance a plane bisecting it, or otherwise passing through it, then it is a continuous boundary between two three-dimensional regions of the specimen. In light of this it will be understood that a surface being partly or wholly “interior” to a specimen does not necessitate or otherwise indicate that there is any internal interface or physical boundary present in the specimen, or that the continuous boundary demarcates any particular mediums or regions containing different types of material. On the contrary, the notional surface may be arbitrary and/or, independent of any topographical or structural features of the specimen, and/or defined by the manner in which the data was acquired from the specimen rather than any particular qualities thereof.

The abovementioned target portion of the specimen may itself be considered to be a surface as defined in this way. Therefore the said plurality of target locations may be thought of as being in a surface coincident with the specimen. Likewise the target or mapping portion may be, partially, or wholly, continuously for a non-zero area thereof, in the surface coincident with the specimen. The surface may be partly or wholly internal to the specimen. The surface may be partly or wholly coincident with an outer surface of the specimen, that is an interface between the specimen and an external medium or environment.

Whether the surface in which the target locations lie is planar, for example a two-dimensional section of the sample, a curved plane, or is more complex or irregular in its topology, for example having one or more points that deviate from an average plane defined by the sampled locations, or from a plane in which the majority or a predetermined proportion of target locations lie, the surface, or the target portion, may preferably be mapped or projected onto a two-dimensional array of points. In other words a correspondence may be defined between each of the plurality of target locations in the target portion of the specimen and each of a plurality of locations in a two-dimensional pixel array, or image, such as a map of distortion information. In this sense the surface, or the mapping portion, may be considered to be two-dimensional, in that it typically has an extent, and may define a coordinate axis or system, in each of two (typically, or at least locally) orthogonal dimensions, regardless of whether the distribution of target locations within the specimen has any extent in a third (typically orthogonal) dimension.

The configuration of the surface, or the target portion that may be considered to be, conform to, correspond to, or be coincident with continuously across at least part of it, is typically defined by the properties of the instrument or scanning procedure used to acquire the data to be employed in the method. In preferred embodiments, the analyses are performed on a two-dimensional section through the specimen, and consequently the scanned data preferably represents a two-dimensional target portion. However, in some embodiments this is less practical or not possible. For example, an irregular outer surface of a fracture can be measured using EBSD, and/or a non-planar surface such as a curved outer surface of a sample may be measured. For example, localised deformation on the curved outside surfaces of objects may be analysed. Typically, the data set provided for use in the method corresponds to a set of scanned locations lying within a given surface, some or all of which may be internal, external, irregular, curved, or planar and in some cases lying within a surface that is a plane. Preferably the mapping portion is planar, and may constitute the entirety of, or be selected or extracted from, a provided data set. Thus, in some preferred embodiments the plurality of target locations is in a plane coincident with a specimen.

The plurality of regions of the specimen may be understood as sub-portions of the target portion, that is of the mapping portion. The regions may therefore be understood as regions of a surface coincident with the specimen. The regions typically lie within, and can typically be considered to be two-dimensional in the same sense as, that surface and that mapping portion. Namely, for the purposes of the method, a region can be treated as a two-dimensional shape bounded by a perimeter loop (upon which Burgers vector calculations for example may be based), regardless of whether deviations from a plane by one or more of the plurality of target locations or perimeter locations cause any of the surface, the mapping portion, one or more of the regions, or one or more perimeters thereof, to have an extent in a third spatial dimension. The method may accordingly be understood as typically involving, for each of the target locations, obtaining crystal lattice orientation information for the specimen at each of a plurality of perimeter locations along a path corresponding to a perimeter of a region of the surface that contains the target location, or corresponding to a region of the mapping portion of the specimen that contains the target location. In embodiments where the surface, and accordingly the mapping portion of the specimen, is planar, the method may therefore comprise, for each of a plurality of target locations in a plane coincident with a specimen: obtaining crystal lattice orientation information for the specimen at each of a plurality of perimeter locations along a path corresponding to a perimeter of a region of the plane that contains the target location.

It will be understood that the surface, and in preferred embodiments the plane, being coincident with the specimen refers to that surface or plane lying wholly or partially on or within the specimen, that is on its surface and/or through its interior volume. In other words, the surface or plane may be understood as intersecting with the specimen, or may in some embodiments be defined as the intersection of a surface or plane with the specimen. In typical embodiments, however, the surface or plane is coincident with a part of the outer surface of the specimen. In such cases, the plurality of target locations and perimeter locations are on the surface of the specimen.

The crystal lattice orientation information that is obtained for the specimen may be thought of, or may be provided as part of an orientation dataset. This dataset may comprise data for a plurality of locations in the plane, or other, non-planar surface, coincident with the specimen. Those locations typically comprise the target and perimeter locations for the region of the specimen being analysed, and may additionally comprise data for locations in one or more further regions. It will be understood that any one or more of, and preferably multiple ones of, the plurality of locations represented in the orientation dataset, may be either or both of a target location and a perimeter location. That is to say, a given location in the orientation dataset may serve as a perimeter location for generating distortion information relating to one region, and may also serve as the target location corresponding to another region. Indeed, a given location may be used as a perimeter location in the generating of distortion information for any number of regions whose perimeters coincide with that location. The regions of the specimen being analysed may be overlapping or non-overlapping regions of the same surface or plane, and/or one or more regions may lie in different surfaces or planes. The regions of the specimen for which an orientation dataset contains usable data may themselves overlap or coincide, as may the planes in which they lie. Preferably a process of acquiring an orientation dataset results in orientation information that may be used to produce distortion information for multiple specimen regions.

The path corresponding to the perimeter of the region, for a given target location, may also be understood as that path defining the perimeter, or being defined by it. The outer boundary of the region from which data or signals has been collected from those perimeter locations need not necessarily be identical to a path passing through the perimeter locations, however. Typically, the perimeter locations might be defined as points located at the centres of respective subregions, which may be thought of as pixels for example, and the said perimeter might be defined by the outer (with respect to the region as a whole, typically) edges of those subregions. Alternatively, in some embodiments, it is envisaged that the perimeter or peripheral subregions are each centred on the perimeter line for the region.

The region of the surface or plane, for a given target location, might also be defined as a region in the surface or plane. In other words, the region is typically defined as a two-dimensional region, that is a region that is a portion of the surface or plane.

The distortion information is typically representative of a magnitude and/or direction of crystal lattice distortion attributable to crystal lattice dislocations within the region. The crystal lattice may also be referred to as an atomic lattice. The crystal lattice distortion may be attributable to one or more crystal lattice dislocations within the region. Such dislocations may be understood as being within the region in the sense that they intersect, or are at least proximal to, the portion of the surface or plane that corresponds to the given region for the given target location.

As alluded to above, each target location and perimeter location may be understood as being coincident with the specimen. That is, each of those locations is typically either within the specimen or on its surface.

In some embodiments, for each target location, the generating of distortion information comprises combining the crystal lattice orientation information obtained for at least a subset of the plurality of perimeter locations along the path corresponding to the perimeter of the respective region. In other words, the information representative of crystal lattice orientation at locations around the perimeter of each region may be advantageously taken in combination in order to generate the distortion information for that region, or for the corresponding target location within.

Preferably, that combining comprises calculating an integration of, or in other words integrating or integrating over, crystal orientation gradient values around the said perimeter of the region. Approaches for generating the distortion information in this way are set out in greater detail later in this disclosure.

As noted above, the plurality of target locations are preferably on the surface of the specimen. Accordingly, in such embodiments, each region is typically on the surface of the specimen also.

Preferably, the set of output data comprises, or is representative of, a lattice distortion image for the specimen. The lattice distortion image typically comprises a plurality of pixels corresponding to the plurality of target locations. Typically, the pixels have values corresponding to the generated distortion information for the respective target locations. In this way, the aforementioned dislocation information maps or images may be produced by way of the method. Owing to the advantageous overlapping-region approach described above, such lattice distortion images may exhibit higher degrees of detail and variation in values across the pixels, and may more precisely represent distortions present in the specimen, than conventional techniques.

The method may, in some embodiments, further comprise acquiring, based on the distortion information, dislocation classification data for each of the plurality of target locations. It may be advantageous in some applications to categorise or classify, preferably automatically, or without requiring user intervention or input, lattice dislocations indicated or represented by the obtained data.

In such embodiments, preferably, for each target location, the distortion of classification data is acquired in accordance with one or more of: dislocation density information inferred from the distortion information; and one or more values or information indicating lattice distortion orientation information inferred from the distortion information.

The method may be applied using a wide variety of crystallographic orientation datasets that typically comprise data collected from a plurality of regularly arranged or spaced locations on or in a specimen. Typically, the collection of such data may involve an electron beam and backscattered electrons, that is electron backscattered diffraction (EBSD). However, it is also envisaged that data obtained using transmitted electrons, for example in transmission Kikuchi diffraction (TKD) in a scanning electron microscope, or one of several transmission electron microscope (TEM) techniques. The data may also be generated from data collected using X-ray techniques, or optical approaches such as Raman analysis. Typically, any of these data collection methods may produce data representative of crystal lattice orientation at a plurality of locations that are regularly arranged in an array laying within a surface or plane coincident with the specimen. Typically, any such grid of orientation data may be utilised in the method.

In some embodiments, therefore, a plurality of locations comprising the pluralities of perimeter locations or the plurality of target locations are arranged in a periodic grid in the specimen. The grid is typically an arrangement of locations that are regularly spaced or distributed across the mapping portion of the specimen, and may be thought of as being arranged within the surface coincident with the specimen. If the orientation dataset relates to a two-dimensional, planar section or external surface of the specimen, the surface can be considered to be a plane coincident with the specimen, and the grid may be a periodic two-dimensional grid in a plane, in particular in a planar intersection between a plane and the specimen. Typically the grid is on the surface of the specimen, preferably, the grid is an orthogonal or hexagonal grid. The plurality of locations typically comprise the plurality of target locations and the plurality of perimeter locations therefor. In other words, there may be defined a regular array of locations in the plane, and the perimeter locations for which crystal lattice orientation information is obtained may be included in that array of locations. The grid or array is typically two-dimensional, and may correspond to a two-dimensional portion of the specimen, defining orientation data for the array of points lying within the plane of that portion. Typically, data for the grid of points is provided, and that data is then used by defining a plurality of overlapping regions, or tiles, made up of overlapping sub-grids of the grid. The method may comprise obtaining data for all or a subset of the locations to which the acquired specimen data, or the grid, corresponds. Such a subset typically corresponds to a target portion of the specimen, for which distortion data is desired.

Typically, for one or more, preferably all, of the plurality of target locations, the perimeter of the respective region, and therefore typically the region itself, defines its circular, or at least substantially circular, shape. It will be understood that, owing to the presence and shape of sub-regions or pixels around the perimeter of each region for which the obtained orientation data contains information, the outer boundary defined by those sub-regions might not be a smooth circle, but might be made up of discontinuous portions that conform on average to a circular “footprint” for each region.

Alternatively, or additionally, one or more of the plurality of target regions, and in some embodiments for all of the target locations the parameter of the respective region defines a regular hexagon shape. Although the method may be applied using regions of various shapes, including ellipses and shapes that are geometrically irregular, it has been found that orthogonal and hexagonal geometries produce improved results. Typically, for each of the plurality of target locations, the respective region has the same size and/or shape.

Typically, for one or more, preferably all, of the plurality of target locations, the target location is at a centroid, or the geometrical center, of its respective region.

In some embodiments, the method may further comprise, for each of the plurality of target locations, defining the respective region as an array of pixels, preferably a regular array. Typically the array corresponds to a sub-grid of the aforementioned periodic grid. The respective plurality of perimeter locations, for each of the plurality of target locations, typically corresponds to a peripheral subset of the array of pixels. Typically the pixels are equal in extent, that is they occupy portions of the plane (or typically of the specimen surface) that are equal in area and/or size. The pixels are typically rectangular, and preferably square, but may be hexagonal, for example if the orientation dataset provided comprises a contiguous hexagonal grid pixel. Orientation data for a given pixel may have been obtained from an area, volume, or portion of the specimen that is equal, larger, or smaller in extent than the pixel. For example, a signal, such as a backscattered or transmitted electron signal, from which orientation data for a location or pixel has been derived may have been omitted from an interaction volume that has a smaller extent or intersection within the plane than the pixel. For instance, pixels may be one micrometre across, and may be associated with orientation data collected from a volume or area that is several nanometres across. In any case, typically the orientation data is associated with that pixel.

In some such embodiments, the peripheral subset of pixels substantially surround the region, or surround, or enclose, an interior portion of the region. Typically, each of the peripheral subset of pixels is situated at the outer boundary of the region. Depending upon the extent of the pixels, the peripheral subset thereof may partially or at least substantially entirely enclose the region. That is, in some embodiments, adjacent pixels, including peripheral pixels, may be spaced apart, or may overlap, but are preferably contiguous. Preferably, the peripheral pixels for which orientation data is used to generate distortion information for a target location form a closed periphery or closed loop, around the outer boundary of the region or array. Typically, a closed periphery of outer pixels is defined, and preferably all of the pixels in that periphery are used to generate the distortion information for the target location corresponding to, and within, that region.

In embodiments such as this, preferably each region containing one the plurality of target locations partially overlaps another region such that only pixels comprised by the peripheral subset of pixels of the region do not overlap any pixels of the another region. Preferably, for two overlapping arrays, a single row of pixels in each array is excluded from the intersection, that is from the area of overlap. In this way, the degree of overlap between adjacent regions is maximised, as is the spatial resolution of the output data.

The plurality of target locations are typically arranged in a regular array within the surface or plane, and typically on the surface of the specimen. As alluded to above, various types of orientation dataset may be used. The periodicity, or spatial period, between locations in the dataset, or the centroids thereof, may vary considerably for different embodiments. For example, when using data obtained in a TEM, the spacing between adjacent locations may be approximately one nanometre or smaller. In other embodiments, the spatial period may be in the order of one micrometre.

The method may, in some embodiments, involve the collection of the orientation data from the specimen. Thus, in some embodiments, the obtaining of the crystal lattice orientation information comprises: causing a particle beam to impinge upon the specimen so as to cause resulting particles to be emitted from a plurality of locations in the specimen, in particular in the mapping portion thereof, or the surface or plane coincident with the specimen, the plurality of locations including the plurality of perimeter locations for each region containing one of the plurality of target locations; and monitoring the resulting particles using a detector device, so as to obtain the crystal lattice orientation information for the specimen at each of the plurality of locations. Typically this therefore involves causing a particle beam to impinge upon the surface at a plurality of locations on the surface of the specimen, that is the target and perimeter locations are on the surface. Typically, the said plurality of locations may be understood as being the same as the plurality of locations mentioned above, that is the plurality comprising the pluralities of perimeter locations, and preferably also comprising the plurality of target locations.

Typically, the particle beam is an electron beam, and the resulting particles comprise electrons. The method may further comprise monitoring X-rays omitted from the plurality of locations so as to obtain chemical composition information for the specimen at the plurality of perimeter locations. In any of these embodiments, the resulting electrons may comprise electrons backscattered by the specimen. The resulting electrons may alternatively or additionally comprise electrons transmitted through the specimen.

In accordance with a second aspect of the invention there is provided a computable readable storage medium having stored thereupon a program code configured for executing the method according to the first aspect.

### BRIEF DESCRIPTION OF THE DRAWINGS

Examples of the present invention will now be described, with reference to the accompanying drawings, in which:

FIG. 1 shows an EBSD orientation map of a cracked duplex stainless steel sample;

FIG. 2 is a schematic illustration of edge and screw dislocations;

FIG. 3 shows two schematic illustrations illustrating (left) how dislocations of the same sign will contribute to a significant bending of the crystal lattice (i.e. plastic deformation), whereas dislocations of mixed signs and (right) will cancel each other out and not result in any significant lattice bending;

FIG. 4 shows, Left: schematic illustration of the determination of a KAM value on a 3×3 pixel array, and Right: an example KAM map of a cracked duplex stainless steel sample;

FIG. 5 shows two Burgers circuits in crystal (left) and sample (right) reference frames;

FIG. 6 is an orientation map of a Mg-alloy showing weighted Burgers vector loops;

FIG. 7 is a table showing weighted Burgers vectors for the loops in the example of FIG. 6;

FIG. 8 is a schematic illustration showing a conventional weighted Burgers vector integral loop tiling approach;

FIG. 9 is a schematic illustration of an example sliding weighted Burgers vector integral loop approach according to the invention;

FIG. 10 shows a comparison between a conventional loop approach and an example sliding loop approach according to the invention, for the same example geological dataset;

FIG. 11 shows a comparison between data obtained via different example weighted Burgers vector calculation approaches on an example GaN thin film;

FIG. 12 shows a comparison of the use of a square pixel loop with a circular loop in an example method according to the invention, on the same example GaN dataset; and

FIG. 13 is a flow diagram illustrating steps comprised by an example method according to the invention.

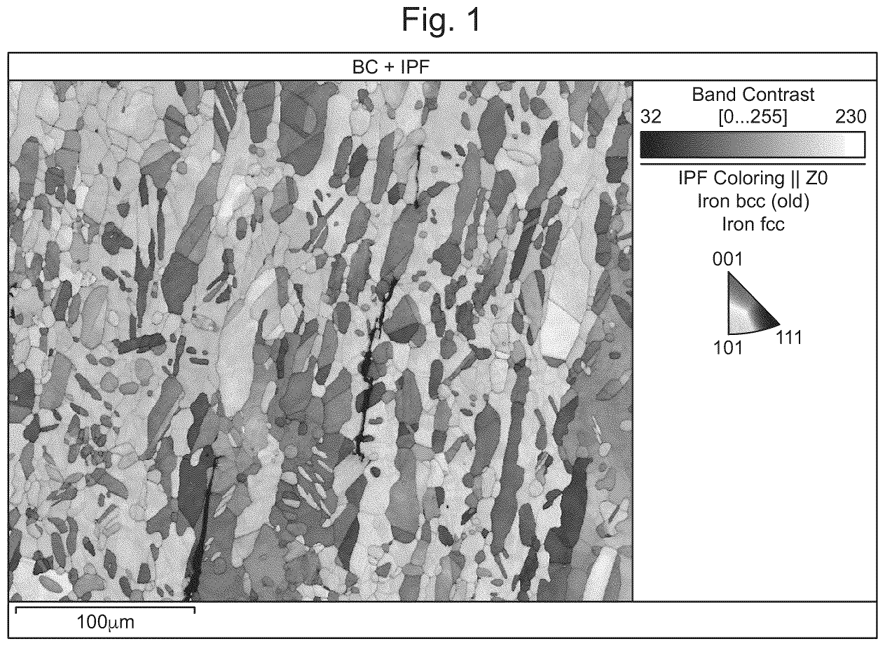

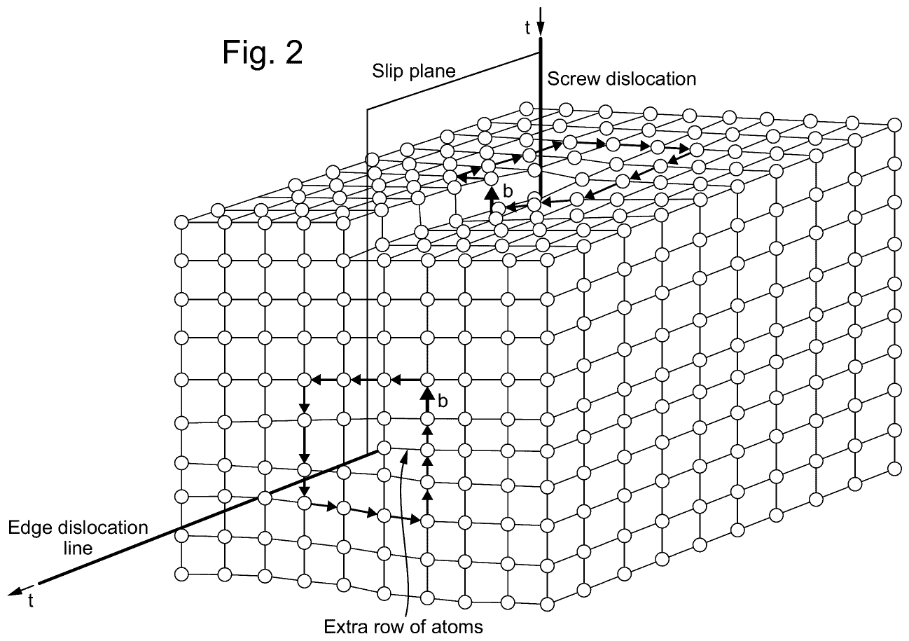

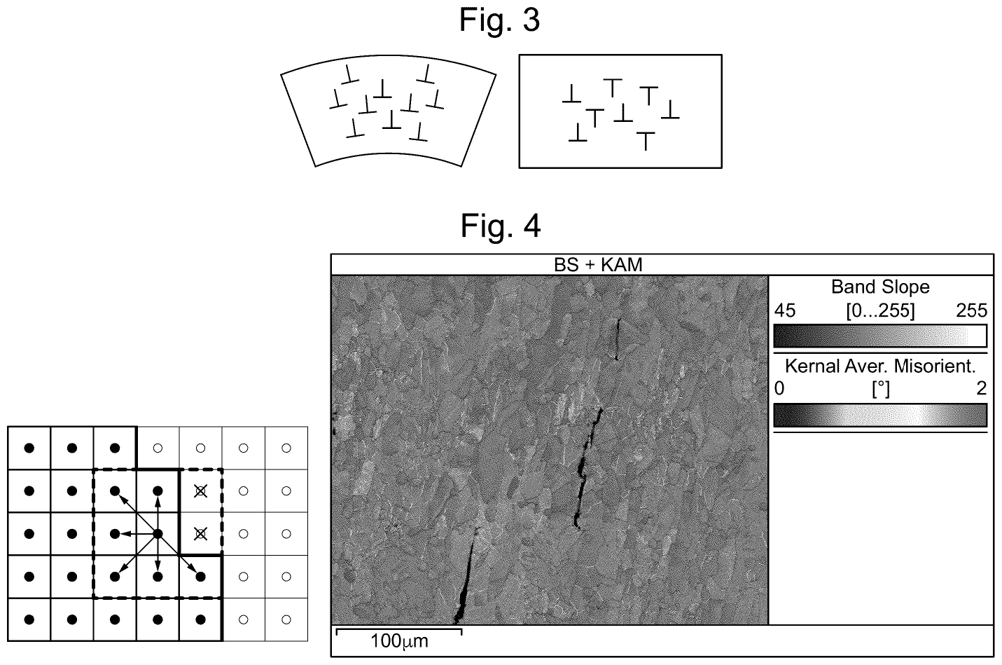

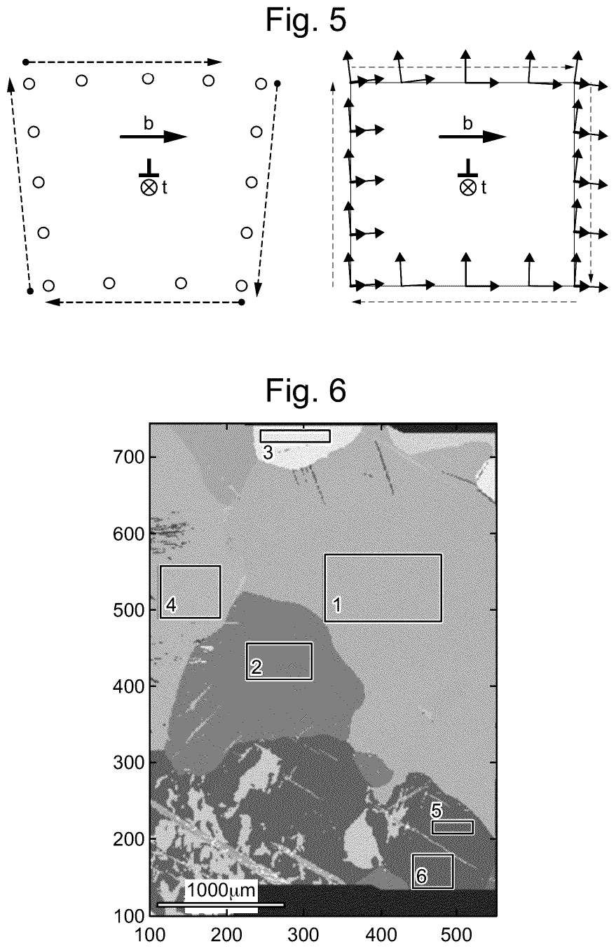

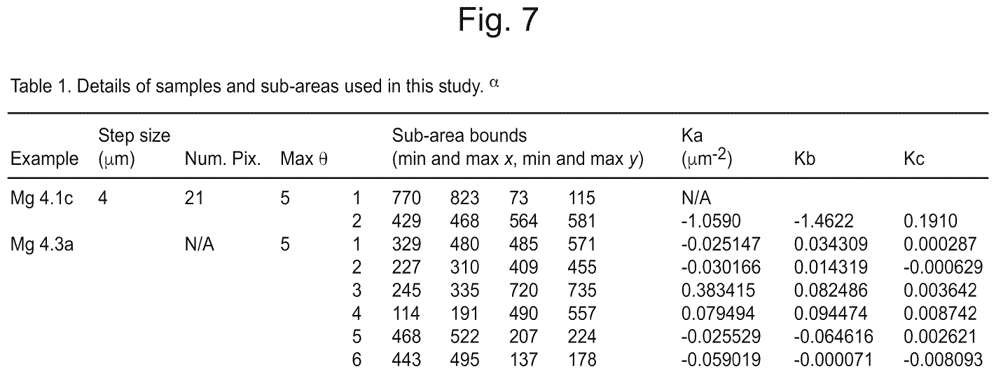

### DESCRIPTION OF EMBODIMENTS

With reference to the accompanying drawings, example methods for analysing lattice distortion in a specimen according to the invention are now described.

Example methods may provide a modification of the WBV integral loop tiling approach as proposed and published by Wheeler et al. (2009) and Timms et al. (2019). The major drawbacks of the WBV technique as previously used are as follows:
1. The differential approach is susceptible to errors, due to the relatively small measured disorientations and thus the increased impact of any imprecisions in the orientation measurement.
2. The integral loop tiling approach overcomes this first drawback, but suffers from a significant loss of spatial resolution and thus a loss of microstructural detail, plus is restricted to rectangular or square loop shapes (unless a hexagonal grid has been used for data collection)

Instead, we propose the use of the integral loops, but used as a “sliding” loop around each pixel, as shown below. The basic principles of this approach are as follows.

### Weighted Burgers Vector Calculation

To define the Burgers vector mathematically in terms of EBSD measurements, we calculate how a closed path in an undistorted reference system (“sample system”) is looking like in the locally deformed (rotated, possibly strained) crystal structure coordinate system. For a closed loop Lₛₐₘₚₗₑ on the sample surface, there is a corresponding path C_{crystal} in the crystal coordinate system, which, due to the bending of the material, is not necessarily closed anymore. The extra distance from the end point of the path to the starting point in the crystal system is related to the net Burgers vector of all dislocation line components normal to the closed Lₛₐₘₚₗₑ loop, the “Weighted Burgers Vector, WBV” as introduced in Wheeler et al. (2009).

If elastic deformations are ignored, the steps along both curves are related by the rotation matrices ϑᵢₐ which describe the local orientations. The Burgers vector is calculated as the value of the integral along the path in the crystal system according to equations (5) and (15) in Wheeler et al. (2009):

$${B}_{\text{?}} = - {∮}_{{L}_{sample}} {\sum }_{α = 1}^{3} {g}_{\text{?} α} {dx}_{α} = - {\int }_{{C}_{Crystal}} {dX}_{\text{?}}$$

$$\text{?} \text{indicates text missing or illegible when filed}$$

Because 2D EBSD measurements are confined to the x-y-plane of the sample coordinate system, only the resulting Burgers vector of dislocation lines with a z-component in the sample system can be sensed (the WBV).

The “sliding loop” approach uses the equations (5) and (15) in Wheeler et al. (2009) in the way that the center points of a loop Lₛₐₘₚₗₑ of a given shape are taken over all given 2D map points, i.e. there are as many loops as map points. In this way, a local average WBV is calculated for each individual map point, increasing the spatial resolution as compared to a “tiling” approach.

### Example Method

FIG. 9 illustrates a sliding WBV integral loop approach, using 5×5 sized tiles, as may be used in an example method. Although the WBV calculated at each point is based on the summed Burgers vectors around the loop, the spatial resolution integrity of the data is maintained. Note that, although the loops are displayed here with a square shape, they can also be approximately circular.

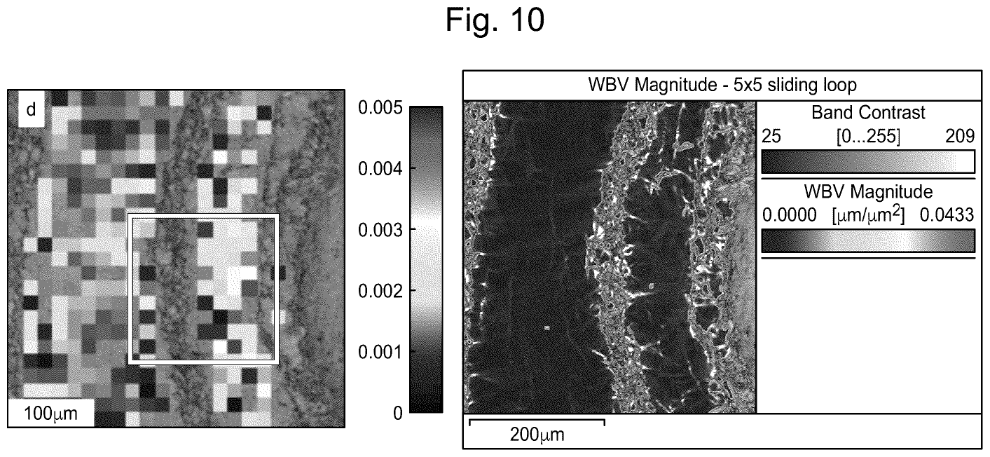

The impact of this sliding loop approach is significant. The technique retains the resolution of the original data (although dislocation structures will be smoothed in relation to the chosen size of the loop) but benefits from the integral loop approach's superior accuracy and lower noise level relative to the differential approach. The resolution improvement is illustrated in the example shown in FIG. 10.

The figure shows a comparison between a conventional loop approach (left) and the sliding loop approach (right) on the same geological dataset. Note the superior resolution of small dislocation structures in the sliding loop data, although these analyses were not carried out using the same loop size.

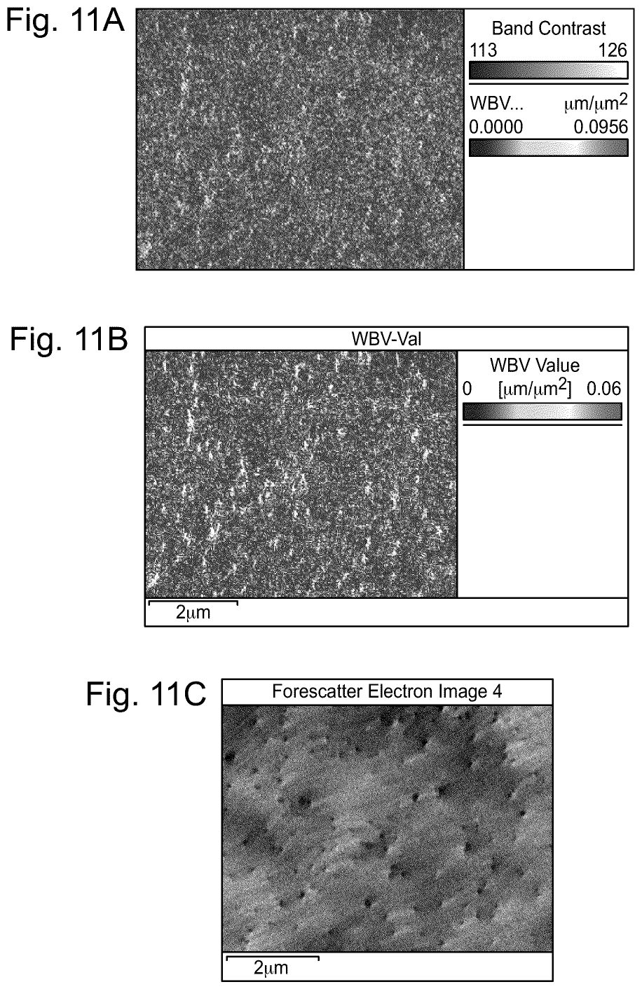

The sliding loop approach's superior accuracy and lower noise level compared to the differential approach is demonstrated in the following example. The images compare the differential WBV approach with the sliding integral loop approach on a GaN thin film with individual threading dislocations (these are isolated dislocations that thread through the sample due to a mismatch between the GaN thin film and the substrate material and are visible in the corresponding electron image). The reduction in noise with the sliding integral loop approach is very clear, and the benefits of using a circular loop shape are displayed in FIG. 11.

The figure illustrates a comparison between different WBV calculation approaches on a GaN thin film. A-differential WBV method. B-sliding integral loop approach. C-channelling contrast electron image showing the individual dislocations. Note the improved signal to noise in the sliding integral loop WBV method. Both techniques used a 3×3 square pixel array.

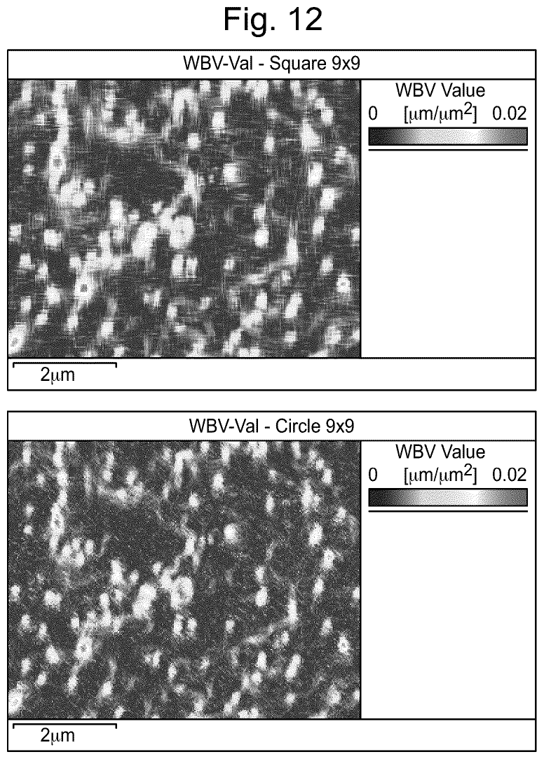

FIG. 12 shows a comparison of the use of a (left) square 9×9 pixel loop with a (right) “circular” 9×9 loop (within the confines of an orthogonal measurement grid) on the same GaN dataset. Note the horizontal and vertical artefacts visible when using a square loop.

The implications of the sliding loop approach compared to previously published techniques are clear from these examples and will permit significantly more powerful analyses of dislocation structures from orientation map data, such as typically generated using the EBSD technique.

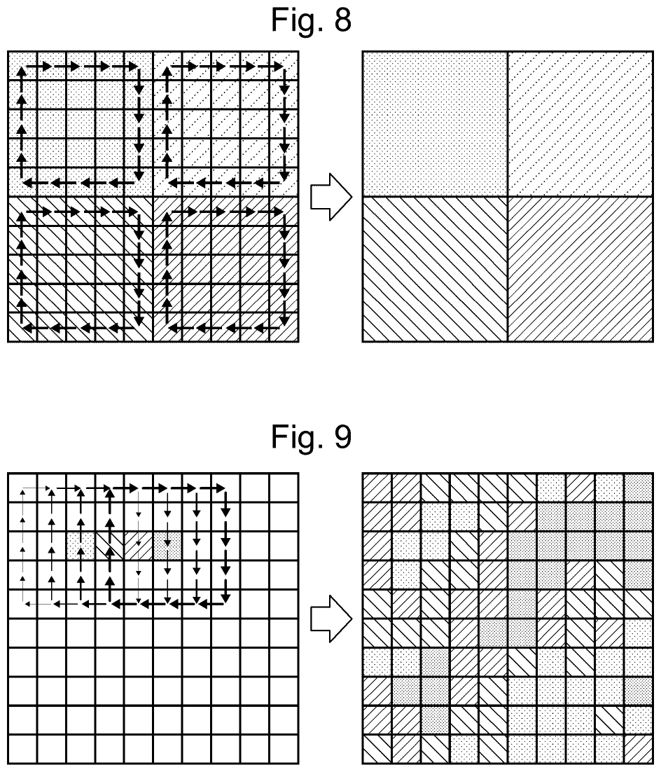

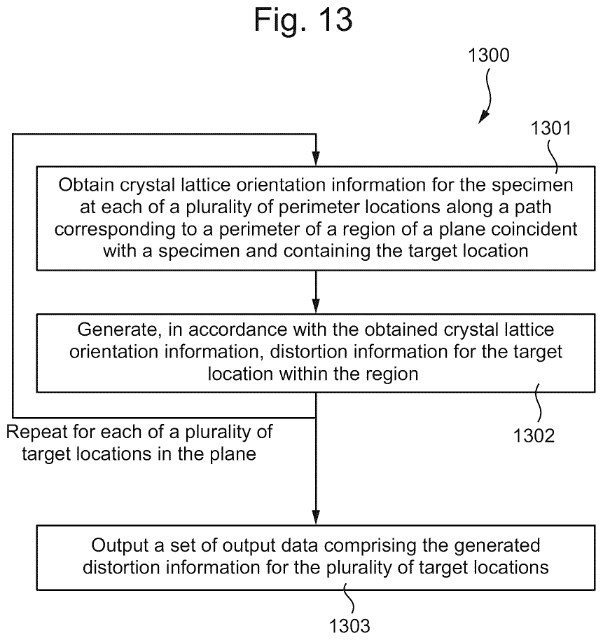

FIG. 13 shows an example method 1300 of analysing lattice distortion in a specimen, which may employ the “sliding loop” principles described above and illustrated for instance at FIGS. 8-9.

The example method involves performing the steps of both obtaining crystal lattice orientation information 1301 and generating distortion information in accordance with that crystal lattice orientation information 1302, in respect of each of a plurality of target locations within a part of a specimen. Each of the target locations, which may be referred to as map points, is typically on or at the surface of the specimen, but may alternatively be within it, that is beneath its surface.

In the present example the orientation dataset comprises a set of data acquired by way of electron backscatter diffraction (EBSD) using a scanning electron microscope (SEM). As described earlier in this disclosure, the data set contains a plurality of EBSD measurements for a corresponding plurality of locations in a scanned part of the specimen. In the present example the orientation dataset has been acquired prior to commencing the method. However in other implementations the method may be performed partly or entirely concurrently with the acquiring of the dataset from which the crystal lattice orientation information is obtained.

In the present example, the orientation dataset has been produced by way of performing EBSD analysis on a two-dimensional section through the specimen. In preferred embodiments the dataset accordingly represents a plurality of points that likewise lie in a single plane, and the regions containing the target regions are accordingly planar regions, and may be thought of as regions of a plane, or of one or more respective planes. However, in other examples it might not be possible or practical to obtain data for a planar section of the specimen. In some cases the dataset, and one, more, or each of the regions may represent, or include data for, locations within the specimen that do not necessarily lie in a plane. For example, an irregular outer surface of a fracture surface can be measured using EBSD, and in some examples a curved outer surface of a sample may be measured in order to acquire the orientation dataset.

Generally, and in the present example, the entirety of the scanned specimen portion that is represented in the orientation dataset is analysed. Thus the output data maps the whole area or section scanned in the SEM. However, in some cases a specific sub-area of the scanned part might be selected, corresponding to a subset of the orientation dataset, for example to examine the deformation at a crack tip, at a sample surface or in a specific grain or phase.

In the present example the orientation dataset from which the crystal lattice orientation information for the specimen is obtained is comprised of 60,705 orientation measurements, collected using an orthogonal grid with 25 nm spacing between each measurement. The data are typically stored in a hierarchical data format (HDF), with the orientation data for each measurement being saved as three Euler angles. In this example this data is stored together with additional information relating to diffraction pattern quality, measurement parameters and indexing settings.

The presently described example technique may be used to examine data ranging from 10,000 analyses to 50 million, at measurement spacings ranging from several nanometres to several micrometres. However, datasets outside these ranges are envisaged for various embodiments, and the methods set out in this disclosure are applicable to suitable orientation datasets of any size. Preferably the measurement spacing is significantly smaller (e.g. an order of magnitude smaller) than the average grain diameter of the material under analysis, in order to resolve the structures relating to dislocations. For most deformed materials, the absolute resolution of the EBSD technique (typically in the order of 10-100 nm) limits how small the measurement spacing can effectively be set, so that the integral loop method will almost always enclose multiple dislocations. Therefore the net weighted Burgers vector content is measured. In certain cases, such as with the GaN thin film shown in FIGS. 11 and 12, the individual dislocations are sufficiently spatially distinct to be individually measureable using this method.

The analysis of lattice distortion benefits from higher-precision orientation measurements. Although standard EBSD measurements (with an angular precision in the range of 0.1-0.5° for example) can be used with the current method, for the effective characterization of very small orientation changes, such as around the individual threading dislocations in this GaN thin film, higher-precision orientation measurements are desirable. In this example the diffraction pattern indexing has been performed using an iterative refinement method (“Refined Accuracy” indexing, as described in US 2015/0369760 A1 for example), providing an angular precision <0.05°. Further improvements are possible using recently developed pattern matching approaches, enabling angular precisions of ˜0.01°.

A part of the specimen for which the two-dimensional map representative of crystal lattice distortions therein is to be produced is defined by a set of map points. The target locations, or map points, may define, or be arranged within, a map portion, typically an effectively two-dimensional portion, of the specimen. In the present example this set is a subset of points for which the orientation dataset provides orientation measurements. It is also envisaged that the entirety of a scanned region may be mapped in some implementations, which may entail the entire set of measured locations within the specimen represented by the orientation dataset. The map points are chosen, in the present case, based on a predetermined or previously identified area or feature of interest on or in the specimen. The map points correspond to locations within the specimen that are arranged as a regular, two-dimensional, rectangular array, due to the scanning and sampling parameters of the SEM. However, other array types and distributions of sampling points may be used.

For each of the map points, or target locations, within the array, a region containing the map point is defined. These regions may be thought of as sub-portions of the two-dimensional specimen portion represented in the EBSD orientation dataset, and each delineates a sub-set of orientation data that is to be used in generating the distortion information for a given location in the specimen, or for a given pixel of the distortion map. Each of the established regions contains, and defines the sub-set of orientation information that will be used to calculate the distortion for, a different one of the map points. The distortion information is representative of crystal lattice distortion attributable to crystal lattice dislocations within the region as described above. The distortion information is calculated using the integral loop technique, and so the method benefits from the higher-quality GND data, in which the effect of noise in the EBSD data is reduced, that this provides.

By contrast with the known, contiguous-tile approach exemplified by FIG. 8, however, the example method involves defining these regions such that they overlap. The introduction of an overlap between adjacent ones of the regions or “tiles” that define how the distortion information is generated permits a significant enhancement to the resolution of the spatial information representing distortion within the specimen portion. The overlapping tiles may also be referred to as loops, in reference to the series of data points corresponding to the closed loop around the perimeter of each region. Thus in the context of methods described in this disclosure, the terms “tile” and “loop” may equally be understood to refer to the overlapping regions based on which distortion information for the target locations inside and corresponding to the tiles or loops is generated.

In the present example method the regions overlap one another in the manner depicted in FIG. 9, that is the plurality of tiles have the same positioning relative to another as do the plurality of target locations or map points. This arrangement, whereby the differences in position between the regions are the configured to be the same as the spacings between the corresponding map points, achieves a high-spatial resolution output data set. This is because the output spatial resolution is the same as that of the array of map points.

In the present example this is the same as the spatial resolution provided by the orientation dataset from which the crystal lattice orientation information is obtained at step 1301. However, it is envisaged that one or more or, or all of, the target locations or map points that will be represented in the output image might not correspond exactly to specimen locations represented in the provided orientation dataset. That is, the correspondence between target locations and locations in the orientation dataset might not be one-to-one, as in the present example, but might be one-to-two, or one-to-many. In such variations, the output distortion map may be of lower resolution, that is comprising fewer pixels to represent a given area or two-dimensional portion of the specimen, than the orientation dataset obtained by the EBSD analysis.

In this example the tiles are defined as square regions. However, the regions can be defined with any suitable shape, for example in accordance with a particular arrangement of the grid or array represented in the orientation dataset. In some implementations the regions, or at least some of them, are defined as regular polygons of the same type, for example rectangles, triangles, and hexagons. The plurality of regions may alternatively comprise one or more regions of a second, third, or further different type. The sizes and shapes of the regions may also be configured in dependence on predetermined features of the specimen, for instance to exclude or include a particular feature from an integral calculation.

In the present example, all tile regions defined for the purposes of the method are the same size, in particular having the same area and same shape. It is advantageous for the tiles to be of the same size and shape for each pixel, in order to facilitate direct comparison of the output from pixel to pixel. Various applications, specimens, and scanning conditions may necessitate using different tile shapes and sizes. However, for a given analysis of one dataset, these tile properties preferably remain constant. Mixing shapes or sizes for a single analysis of one dataset would give results that render impractical or impossible the comparison of one tile to another, and would preclude the correlation the weighted Burgers vector magnitudes from one part of a map to another, since the size and shape will affect the degree of spatial smoothing and thus the absolute magnitudes.

It is envisaged that some implementations may involve only sampling every nth pixel, as a way of speeding up the process. However, even with large datasets, the time required for the described calculations is typically in the order of 10 seconds, and it is therefore preferred to use the exact correspondence depicted in FIG. 9. Additionally, in this example the tiles have the exact same relative arrangement as the pixels to which they relate. That is, the tiles are all one pixel width/height removed from one another. This offers the maximum resolution for a given SEM dataset.

The spatial extent of the tiles may be chosen or configured in dependence on the dataset. For instance it may be defined with a view to finding an optimal balance between the data quality and the extent of the “smoothing” produced in the image. For data collected with very high angular precision (e.g. using the latest pattern matching techniques) small tile sizes may be defined. For example, as only the nearest pixels in a 3×3 square, or possible a “diamond” shape. For data with poorer angular precision, increasing the tile size will improve the reduction of orientation noise, giving better measurement of the dislocation content but at the expense of spatial resolution (the data will be spatially smoothed).

Each tile overlaps with at least one tile that contains and corresponds to a different target location. Preferably, each tile overlaps with multiple other tiles, owing to the minimum inter-tile centroid distance, or the minimum difference between tile positions defined in any other manner, being less than the extent of the tiles in the direction of the vector defined by that separation, at least. Preferably the linear tile sizes are multiple times the minimum inter-tile position differences, as is the case in the present example.

The method proceeds, with crystal lattice orientation information being obtained at 1301, and distortion information being generated based thereon at 1302, for all of the plurality of target locations. In this example steps 1301 and 1302 are performed for all of a rectangular array of target locations contained in the orientation dataset. The method 1300 shows these steps as being performed as a repeated sequence of step 1301 followed by step 1302 for each target location in turn. Indeed, the process of the tile regions may itself be performed for each tile region, containing each target location, in turn. This might permit the size, shape, or arrangement of tiles to be varied as the method progresses.

However, it will be understood that the order depicted in the flow diagram need not necessarily be followed. For example, crystal lattice information may be obtained for more than one, or possibly all, target locations in a target map portion of the specimen prior to the generation of distortion information for a given target location.

At step 1303 the generated distortion information is output in the form of a distortion map. This is an image comprising a plurality of pixels, having values that represent the distortion information. In the present example the map is a colour image, with each pixel having a plurality of values that in combination define its colour. The correspondence between pixels values and distortion information may be selected or configured in such a way as to visualise the presence of lattice distortions in an optimally visually distinguishable way, by techniques that are well known in the art.

The representation of distortion data in a digital image and the colour mapping conventions are well known in this field, and are not described in detail here. A method for drawing the weighted Burgers vectors as arrows has been described and shown in the paper by Wheeler et al. 2009, for example.

The outputting the distortion map at 1303 may be performed after all of the distortion information has been generated for the entirety of the plurality of target map points, as depicted in FIG. 13. Alternatively, as alluded to above, the order may depart from this, and the map may be generated concurrently with the ongoing generating of distortion data at 1302. For example the map may be updated with distortion information as it is acquired.

Methods and processes described herein, for example implemented in a computer or other apparatus based on obtained, received, locally or remotely stored orientation information, can be embodied as code (e.g., software code) and/or data. An apparatus that performs the described methods may be implemented in hardware or software as is well known in the art. For example, hardware acceleration using a specifically programmed GPU or a specifically designed FPGA may provide certain efficiencies. For completeness, such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system).

Generally, any of the functionality described in this disclosure or illustrated in the figures can be implemented using software, firmware (e.g., fixed logic circuitry), programmable or nonprogrammable hardware, or a combination of these implementations. The terms “component” or “function” as used herein generally represents software, firmware, hardware or a combination of these. For instance, in the case of a software implementation, the terms “component” or “function” may refer to program code that performs specified tasks when executed on a processing device or devices. The illustrated separation of components and functions into distinct units may reflect any actual or conceptual physical grouping and allocation of such software and/or hardware and tasks. Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

1. A method for analysing lattice distortion in a specimen, the method comprising:
for each of a plurality of target locations in a specimen:
obtaining crystal lattice orientation information for the specimen at each of a plurality of perimeter locations along a path corresponding to a perimeter of a region of the specimen that contains the target location; and
generating, in accordance with the obtained crystal lattice orientation information, distortion information for the target location within the region, the distortion information being representative of crystal lattice distortion attributable to crystal lattice dislocations within the region,
wherein each region containing one of the plurality of target locations partially overlaps another region, containing a different one of the said target locations, and
outputting a set of output data comprising the generated distortion information for the plurality of target locations.

2. A method according to claim 1, wherein, for each target location, the generating of distortion information comprises combining the crystal lattice orientation information obtained for the plurality of perimeter locations along the path corresponding to the perimeter of the respective region.

3. A method according to claim 2, wherein the said combining comprises calculating an integration of crystal orientation gradient values around the said perimeter of the region.

4. A method according to claim 1, wherein the plurality of target locations are on the surface of the specimen.

5. A method according to claim 1, wherein the set of output data comprises a lattice distortion image for the specimen, the lattice distortion image comprising a plurality of pixels corresponding to the plurality of target locations and having values corresponding to the generated distortion information for the respective target locations.

6. A method according to claim 1, further comprising acquiring, based on the distortion information, dislocation classification data for each of the plurality of target locations.

7. A method according to claim 6, wherein, for each target location, the distortion classification data is acquired in accordance with one or more of: dislocation density information inferred from the distortion information; and lattice distortion orientation information inferred from the distortion information.

8. A method according to claim 1, wherein a plurality of locations comprising the pluralities of perimeter locations for the plurality of target locations are arranged in a periodic grid in the specimen, preferably an orthogonal or hexagonal grid.

9. A method according to claim 1, wherein, for one or more of the plurality of target locations, the perimeter of the respective region defines a circular shape.

10. A method according to claim 1, wherein, for one or more of the plurality of target locations, the perimeter of the respective region defines a regular hexagon shape.

11. A method according to claim 1, wherein for each of a plurality of target locations, the respective region has the same size and shape.

12. A method according to claim 1, wherein, for one or more of the plurality of target locations, the target location is at a centroid of its respective region.

13. A method according to claim 1, comprising, for each of the plurality of target locations:
defining the respective region as an array of pixels, wherein the respective plurality of perimeter locations corresponds to a peripheral subset of the array of pixels.

14. A method according to claim 13, wherein the peripheral subset of pixels substantially surround the region and each of the peripheral subset of pixels is situated at the outer boundary of the region.

15. A method according to claim 14, wherein each region containing one of the plurality of target locations partially overlaps another region such that only pixels comprised by the peripheral subset of pixels of the region do not overlap any pixels of the another region.

16. A method according to claim 1, wherein the plurality of target locations are arranged in a regular array within the specimen.

17. A method according to claim 1, wherein the obtaining of the crystal lattice orientation information comprises:
causing a particle beam to impinge upon the specimen so as to cause resulting particles to be emitted from a plurality of locations in the specimen, the plurality of locations including the plurality of perimeter locations for each region containing one of the plurality of target locations; and
monitoring the resulting particles using a detector device, so as to obtain the crystal lattice orientation information for the specimen at each of the plurality of locations.

18. A method according to claim 17, wherein the particle beam is an electron beam, and wherein the resulting particles comprise electrons.

19. A method according to claim 18, further comprising monitoring X-rays emitted from the plurality of locations, so as to obtain chemical composition information for the specimen at the plurality of perimeter locations.

20. A method according claim 18, wherein the resulting electrons comprise electrons backscattered by the specimen.

21. A method according to claim 18, wherein the resulting electrons comprise electrons transmitted through the specimen.

22. A computer-readable storage medium having stored thereon program code configured for executing the method of claim 1.
